(19) United States
(12) Patent Application Publication
(10) Pub. No.: US 2025/0275886 A1
(43) Pub. Date: Sep. 4, 2025

(54) MASSAGE DEVICE WITH DUAL RIGID CLAMP PLATES

(71) Applicant: Zhijun PENG, Foshan (CN)

(72) Inventor: Zhijun PENG, Foshan (CN)

(21) Appl. No.: 19/012,862

(22) Filed: Jan. 8, 2025

(30) Foreign Application Priority Data
Feb. 29, 2024 (CN) 2024102282260

(51) Int. Cl. A61H 23/02

(52) U.S. Cl. CPC A61H 23/0245; A61H 2201/0192; A61H 2201/105; A61H 2201/165; A61H 2201/1695; A61H 2201/5002

(57) ABSTRACT

A massage device, including two rigid clamp plates, binding straps, ultrasonic vibrators and massage heads; shoulder straps are connected to the two rigid clamp plates; the binding straps are on two sides of the two rigid clamp plates respectively; the massage heads are detachably and adjustably installed on the rigid clamp plates; each of the two rigid clamp plates is provided with one of the two ultrasonic vibrators, and when powered on, the two ultrasonic vibrators synchronously drive all the massage heads to perform high-frequency vibration massage.

### BACKGROUND OF THE INVENTION

The present invention relates to the field of human body massage and health care instruments, and in particular, to a massage device with dual rigid clamp plates.

With the continuous progress and development of human society, the pace of life of people is increasingly accelerating. Maintaining a certain posture during working and studying for a long period of time, combined with the lack of effective activities or exercises, greatly hinder blood flow of, for example, upper body muscles, shoulders, and arms, thereby resulting in frequent occurrence of discomforts such as soreness, pain, inflammation, and the like in these body parts. Over time, this can lead to an unhealthy state of the body.

In order to help people solve sub-health problems, the applicant of the present invention has a prior art CN210355322U (application Ser. No. 201920164325.1) filed Jan. 30, 2019 titled “ULTRASONIC AIRBAG INFLATABLE MASSAGE THERAPY AND HEALTH CARE GARMENT”. This patent comprises at least a garment body, a plurality of flat airbags, a plurality of ultrasonic transducers each having a shape of a flat tab, and a plurality of massage protrusions. During use, the flat airbags are inflated, so that the massage protrusions can be pressed tightly against the human body, and the ultrasonic transducers are used for applying high-frequency ultrasonic vibrations to the massage protrusions, so that the massage protrusions tightly pressed against the human body can apply high-frequency ultrasonic massage to the human body. Therefore, the high-frequency ultrasonic vibration massage can penetrate deep into the muscles, promoting the blood flow and circulation, quickly rejuvenating blood cells, facilitating metabolism, and thus boosting the self-immunity of the human body.

Although the above patent of the applicant can help people solve their sub-health problems, it still has the following disadvantages during use: Firstly, the positions on the garment achieving high-frequency vibrations are relatively fixed, and users cannot freely adjust the vibration positions based on their actual needs, thereby resulting in inflexibility during use. Secondly, each high-frequency vibration position requires at least one ultrasonic transducer, accordingly, there will be relatively a large number of ultrasonic transducers being used, and wiring is massive and complicated, thereby resulting in complex wiring and difficulty in production and manufacturing; also, using the plurality of ultrasonic transducers at the same time consumes a lot of electric energy, and the airbags also requires electric energy to operate, thereby resulting in high electric energy consumption of the entire massage and health care garment, making it less energy-saving. Thirdly, the size and dimensions of the garment can affect whether the massage protrusions can be tightly pressed against the human body, therefore, the same garment cannot be suitable for different people of different body types, thereby resulting in a limited range of utility. In view of the aforementioned disadvantages, the applicant believes that this type of ultrasonic massage instrument requires further improvements to better meet people's daily needs for massage and health care.

### BRIEF SUMMARY OF THE INVENTION

In view of the above problems and disadvantages, the present invention provides a massage device with dual rigid clamp plates. The massage device can realize the purpose of synchronously driving all massage heads on a same rigid clamp plate to perform high-frequency vibration massage by powering up one corresponding ultrasonic vibrator, so that there are lesser electric elements and wiring, the structure is simpler, the production and manufacture are easier, and electric energy is saved during use; since the massage heads can be adjusted on the rigid clamp plates, the massage device has a wider range of use by being suitable for people of various body types; also, the massage heads can be detached from the rigid clamp plates and changed in their installation position, therefore, the massage device is more versatile and convenient to use to meet the needs of different users for massage on different body parts.

The present invention is achieved by the following technical solutions: A massage device, comprising two rigid clamp plates arranged in parallel side by side, wherein shoulder straps are connected to top edges of the two rigid clamp plates to connect the two rigid clamp plates into a single unit and form a massage cavity between the two rigid clamp plates; the massage device also comprises binding straps arranged on two sides of the two rigid clamp plates respectively to narrow and fix the massage cavity between the two rigid clamp plates; the massage device also comprises two ultrasonic vibrators and a plurality of massage heads; both of the two rigid clamp plates are provided with a plurality of equally spaced through holes, and the massage heads are detachably and adjustably installed to the through holes via threaded connection; each of the two rigid clamp plates is provided with one of the two ultrasonic vibrators, and when powered on, the two ultrasonic vibrators synchronously drive all the massage heads to perform high-frequency vibration massage.

Preferably, each of the two rigid clamp plates is provided with a concave cavity in the middle, and a corresponding one of the two ultrasonic vibrators is arranged within the concave cavity; a cover shell is provided to cover an opening of the concave cavity to protect the corresponding ultrasonic vibrator.

Preferably, a control panel is arranged on the cover shell of one of the two rigid clamp plates; a control circuit board that is electrically connected to a corresponding ultrasonic vibrator and said control panel is arranged on an inner side of each cover shell.

Preferably, each of the massage heads comprises a massage part with a surface disposed with a plurality of massage protrusions, a screw part connected to the massage part, and two tightening nuts; the screw part is selectively inserted into one of the through holes, and the two tightening nuts are screwed onto the screw part on both sides of said one of the through holes respectively, thereby allowing the screw part to be detachably and adjustably installed in said one of the through holes.

Preferably, a drug supply channel is provided on each of the massage heads penetrating from the surface of the massage part provided with the plurality of massage protrusions all the way through two ends of the screw part along an axial direction of the screw part; one of the two ends of the screw part distal from the massage part is also provided with an interface part connected to the drug supply channel.

Preferably, the massage part is also provided with a recess on the surface of the massage part provided with the plurality of massage protrusions, and the drug supply channel penetrates through a bottom surface of the recess; the massage protrusions are arranged circumferentially around the recess.

Preferably, support legs are detachably provided at four corners respectively of one of the two rigid clamp plates.

Preferably, each of the support legs comprises a support leg body, a threaded protrusion arranged on the support leg body, and a locking nut; the threaded protrusion of the support leg body is inserted into a respective one of the through holes at the four corners of said one of the rigid clamp plates, and the locking nut is screwed onto the threaded protrusion.

The present invention has the following beneficial effects:
(1) By using the aforementioned technical solutions, the ultrasonic vibrators are powered on to drive the rigid clamp plates to vibrate at a high frequency, so that the massage heads on the rigid clamp plates are synchronously driven to perform high-frequency vibration massage. This can greatly reduce the number of ultrasonic vibrators being used, reduce the number of connecting wires, simplify the structure, make the production and manufacture easier, and save electric energy during use.
(2) Since each of the massage heads is adjustably installed on a through hole of a rigid clamp plate via threaded connection, user can adjust the pressure of the massage heads on the body by adjusting the threaded connection of the massage heads when wearing the massage device, so that the massage heads can tightly press against the body to provide high-frequency ultrasonic vibration massage with higher intensity. This allows the user to adjust a degree pressure applied by the massage heads according to specific body conditions, thereby having a wider range of utility by enabling the massage device applicable to and meeting the use requirements of a majority of users.
(3) Since each of the massage heads is detachably installed on a through hole of a rigid clamp plate via threaded connection, users can meet their own needs by detaching a massage head from a through hole and installing it on another through-hole corresponding to the body part that requires massage; accordingly, a vibration position can be freely changed, which makes the massage device highly versatile and convenient to use to effectively meet the needs of different users for massage on different body parts.
(4) Through the arrangement of a massage cavity, the massage device can be conveniently worn on the body so that the body is enclosed by the massage device and receives ultrasonic vibration massage around the body at the same time.
(5) Through the arrangement of shoulder straps and binding straps, when the massage device is worn on the body during use, the massage heads on the two rigid clamp plates can tightly press against the body through mutual cooperation of the shoulder straps, the binding straps, and the adjustable design of the massage heads, thereby obtaining a better ultrasonic vibration massage effect.

### BRIEF DESCRIPTION OF THE DRAWINGS

FIG. 1 is a schematic front perspective structural view of the massage device having dual rigid clamp plates according to the present invention.

FIG. 2 is a schematic rear perspective structural view of the massage device having dual rigid clamp plates according to the present invention.

FIG. 3 is a schematic cross-sectional structural view along A-A section indicated in FIG. 2.

### DETAILED DESCRIPTION OF THE INVENTION

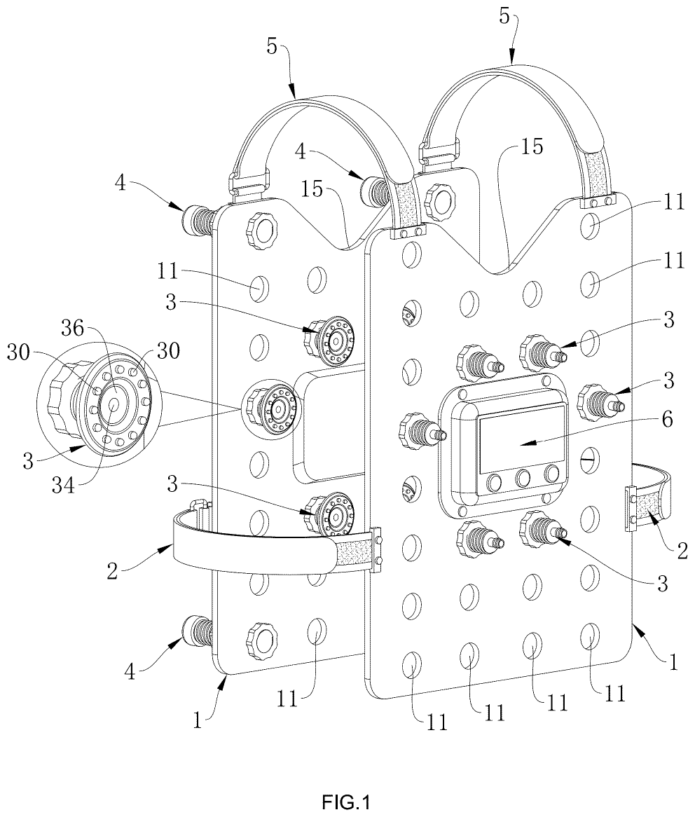

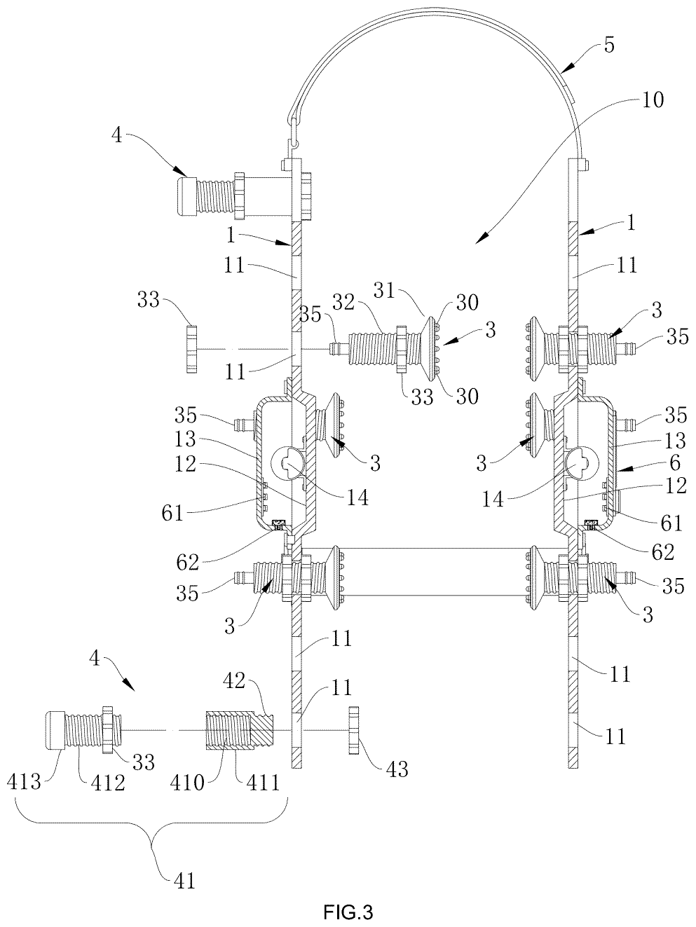

As shown in FIGS. 1 and 3, the present invention discloses to a massage device, comprising two rigid clamp plates 1 arranged in parallel side by side, wherein shoulder straps 5 are connected to top edges of the two rigid clamp plates 1 to connect the two rigid clamp plates 1 into a single unit and form a massage cavity 10 between the two rigid clamp plates 1; the massage device also comprises binding straps 2 arranged on two sides of the two rigid clamp plates 1 respectively to narrow and fix the massage cavity 10 between the two rigid clamp plates 1; the massage device also comprises ultrasonic vibrators 14 and a plurality of massage heads 3; both of the two rigid clamp plates 1 are provided with a plurality of equally spaced through holes 11, and the massage heads 3 are detachably and adjustably installed to the through holes 11 via threaded connection; each of the two rigid clamp plates 1 is provided with one of the ultrasonic vibrators 14, and when powered on, the ultrasonic vibrators 14 synchronously drive the massage heads 3 to perform high-frequency vibration massage.

The present invention can realize the purpose of synchronously driving more than one massage heads 3 to perform high-frequency vibration massage by using one ultrasonic vibrator 14 when being powered on, so that less electric elements and less connecting wires are being used, thereby resulting in simpler structure, easier production and manufacture, and the benefit of energy saving during use; furthermore, each of the massage heads 3 can be adjusted along a direction perpendicular to a corresponding rigid clamp plate 1, thereby ensuring that each of the massage heads 3 can be effectively in contact with the human body to allow the high-frequency vibration energy to be transmitted to the body and thus obtaining a better high-frequency vibration massage effect. Further, the massage heads 3 can be detached from the rigid clamp plates 1, so that the massage heads 3 can be adjusted in position, and thus the massage device is more flexible and convenient to use to meet the needs of a user for massage against different body parts.

In order to prevent the ultrasonic vibrators 14 from being exposed to an external environment, maintain a neat appearance of the massage device, and enhance the safety during use, as shown in FIG. 3, each of the two rigid clamp plates 1 is provided with a concave cavity 12 in the middle, and a corresponding ultrasonic vibrator 14 is arranged within the concave cavity 12; additionally, a cover shell 13 is provided to cover an opening of the concave cavity 12 to protect the ultrasonic vibrator 14. Through the arrangement of the cover shells 13, the ultrasonic vibrators 14 can be effectively encapsulated, providing a dustproof effect; additionally, this design ensures that the user does not come into contact with the ultrasonic vibrators 14 during use of the massage device, thereby enhancing the safety of use. In addition, by arranging the concave cavity 12 in the middle of each of the rigid clamp plates 1, the high-frequency vibration of a corresponding ultrasonic vibrator 14 can be evenly transmitted to all positions of the rigid clamp plate 1, thereby ensuring that all the massage heads 3 on a same rigid clamp plate 1 receives nearly the same amount of vibration, and hence allowing the massage device to achieve more balanced output of ultrasonic vibration massage at different positions of a same rigid clamp plate 1.

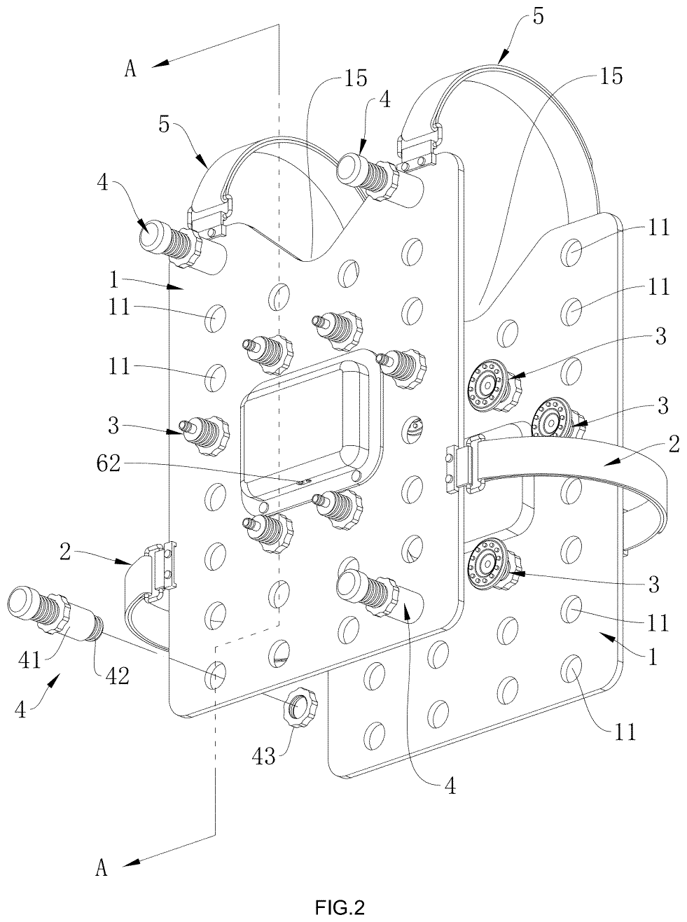

As shown in FIG. 1, in order to facilitate the user to operate the massage device, a control panel 6 is arranged on the cover shell 13 provided on one of the rigid clamp plates 1; a control circuit board 61 that is electrically connected to a corresponding ultrasonic vibrator 14 and said control panel 6 is arranged on an inner side of each cover shell 13. As shown in FIGS. 1 and 2, when the massage device is worn on a human body, it will have one surface corresponding to a front side of the human body which the user have the most convenient access, therefore, the present invention only provides the control panel 6 on one of the rigid clamp plates 1, while the ultrasonic vibrator 14 on another rigid clamp plate 1 without any control panel 6 can be connected to the control panel 6 via wired or wireless communication, thereby allowing the control panel 6 to also control the operation of the ultrasonic vibrator 14 on said another rigid clamp plate 1 without the control panel 6. Each of the ultrasonic vibrators 14 is an ultrasonic vibration motor or an ultrasonic transducer. When each of the ultrasonic vibrators 14 is an ultrasonic transducer, each control circuit board 61 of the present disclosure is additionally provided with an ultrasonic generator or an ultrasonic generating circuit to drive the ultrasonic transducer to operate. As shown in FIG. 2 and FIG. 3, in order to facilitate power supply to different electric elements of the massage device, each cover shell 13 is also provided with a power interface 62 that is electrically connected to the corresponding control circuit board 61. Of course, the massage device of the present invention can also be provided with storage batteries for power supply. In addition, a Bluetooth® communication module or a Wi-Fi® communication module can also be provided in each control circuit board 61, and corresponding application software can be developed and installed on a smartphone so that the massage device of the present invention can be controlled to operate by using the smartphone. Alternatively, an infrared communication module can be provided to each control circuit board 61, thereby allowing the massage device to be operated using a remote controller.

In order to ensure that the massage heads 3 are simple in structure, easy to implement, and convenient for production and manufacturing, as shown in FIG. 3, each of the massage heads 3 comprises a massage part 31 with a surface featuring a plurality of massage protrusions 30, a screw part 32 connected to the massage part 31, and two tightening nuts 33; the screw part 32 is selectively inserted into one of the through holes 11, and the two tightening nuts 33 are screwed onto the screw part 32 on both sides of said one of the through holes 11 respectively, thereby allowing the screw part 32 to be detachably and adjustably installed into said one of the through holes 11. Through clamping by the two tightening nuts 33, each of the massage heads 3 can be securely installed on a corresponding rigid clamp plate 1, making it less likely to be loosen or detached. As shown in FIG. 3, during detachment, it is only necessary to unscrew the tightening nut 33 proximal to an outer end of the screw part 32 from the screw part 32, so that the screw part 32 can be detached from the through hole 11 and thereby removing the entire massage head 3 from the corresponding rigid clamp plate 1. When it is necessary to adjust the massage head 3 to press against the human body, adjustment can be achieved simply by holding the massage part 31 or the screw part 32 and then screwing the two tightening nuts 33 to adjust the positions of the two tightening nuts 33.

In order to enhance the functionality of the massage device of the present invention, as shown in FIGS. 1 and 3, a drug supply channel 34 is provided on each of the massage heads 3 penetrating from the surface of the massage part 31 provided with the plurality of massage protrusions 30 all the way through two ends of the screw part 32 along an axial direction of the screw part 32; one of the two ends of the screw part 32 distal from the massage part 31 is also provided with an interface part 35 connected to the drug supply channel 34. Through the design of the drug supply channel 34 and the interface part 35, the massage device of the present invention can be sold together with a drug supply device. The drug supply device is selectively connected to at least one interface part 35 through at least one pipeline, and drug solutions can be converted to gaseous drug by the drug supply device which then pumps the gaseous drug to at least one corresponding drug supply channel 34 through which the gaseous drug is sprayed onto the human body, thereby achieving a therapeutic effect through steaming of the gaseous drug. An example of the drug supply device is mentioned in CN111939045A (application Ser. No. 201910413695.9) also proposed by the inventor of the present invention.

As shown in FIG. 1, the massage part 31 is also provided with a recess 36, and the drug supply channel 34 penetrates through a bottom surface of the recess 36; the massage protrusions 30 are arranged circumferentially around the recess 36. Through these designs, an outlet of the drug supply channel 34 is prevented from being blocked by the skins and flesh of human body which may move and hence block the drug supply channel 34 when the massage part 31 presses against the human body to perform massage. Through the arrangement of the recess 36, the drug supply channel 34 is spaced apart from the human body to effectively prevent blockage of the drug supply channel 34. By arranging the massage protrusions 30 circumferentially around the recess 36, gaps between adjacent massage protrusions 30 facilitate the outward diffusion of the gaseous drug, thereby ensuring smooth outflow of the gaseous drug.

In order to enable the massage device to be used while user is lying down, as shown in FIG. 2, support legs 4 are detachably provided at four corners respectively on one of the rigid clamp plates 1. During use, the support legs 4 can provide support against the entire massage device and the human body to allow ultrasonic vibration massage even when the user is lying down, also, the massage heads 3 and the interface parts 35 thereon are prevented from directly pressing against a surface of an object on which the user is lying, thereby avoiding damage to the massage heads 3 and the interface parts 35, and ensuring normal operation of the massage heads 3 and the interface parts 35. Through the detachable structural design, user can install or remove the support legs 4 according to practical needs. When the support legs 4 are not needed, they can be detached from the rigid clamp plate 1 to reduce the weight of the massage device if it were to be worn by the user.

As shown in FIG. 2, each of the support legs 4 comprises a support leg body 41, a threaded protrusion 42 arranged on the support leg body 41, and a locking nut 43. The threaded protrusion 42 of the support leg body 41 is inserted into a respective one of the through holes 11 at four corners of said one of the rigid clamp plates 1, and the locking nut 43 is screwed onto the threaded protrusion 42. This design makes the installation or detachment of the support legs 4 very simple and convenient, and the installation is also very stable. In addition, the through holes 11 at the four corners for installing the support legs 4 can also be used to install the massage heads 3 when the installation of the support legs 4 is not needed.

In order that a length of each support leg body 41 is adjustable, as shown in FIG. 3, the support leg body 41 comprises a fastener 411 with a screw hole 410, a support leg member 413 with a screw rod 412, and a tightening nut 33 screwed onto the screw rod 412. Through the length-adjustable structural design of the support leg body 41, an overall height and/or an angle of inclination of the massage device during use by a lied down user can be adjusted, allowing the massage device to be adjustable to different heights and angles of inclination to meet the needs of different users.

As shown in FIG. 1, a quantity of the shoulder straps 5 is two; a cutaway portion 15 is formed on a top edge of each of the two rigid clamp plates 1 between the two shoulder straps 5. Through the arrangement of the cutaway portion 15, a chest bone area below the neck of the user can be avoided from being covered by the rigid clamp plates when the massage device is worn by the user, thereby avoiding vibration on the chest bone area and preventing any impact on breathing. Moreover, by arranging the cutaway portion 15, the material used for the rigid clamp plates 1 can be reduced, thereby lightening their weights and making them more comfortable to wear.

In actual use, in accordance with specific needs of different users, a number of the massage heads 3 installed on the rigid clamp plates 1 can be increased or decreased, and the positions of the massage heads 3 on the rigid clamp plates 1 can also be adjusted as desired. The massage device of the present invention is versatile and convenient to use, capable of meeting different requirements of a majority of users.

What is claimed is:

1. A massage device, comprising:
two rigid clamp plates arranged in parallel side by side; shoulder straps are connected to top edges of the two rigid clamp plates to connect the two rigid clamp plates into a single unit and form a massage cavity between the two rigid clamp plates;
the massage device also comprises binding straps arranged on two sides of the two rigid clamp plates respectively to narrow and fix the massage cavity between the two rigid clamp plates;
the massage device also comprises two ultrasonic vibrators and a plurality of massage heads; both of the two rigid clamp plates are provided with a plurality of equally spaced through holes, and the massage heads are detachably and adjustably installed to the through holes via threaded connection; each of the two rigid clamp plates is provided with one of the two ultrasonic vibrators, and when powered on, the two ultrasonic vibrators synchronously drive all the massage heads to perform high-frequency vibration massage.

2. The massage device of claim 1, wherein each of the two rigid clamp plates is provided with a concave cavity in the middle, and a corresponding one of the two ultrasonic vibrators is arranged within the concave cavity; a cover shell is provided to cover an opening of the concave cavity to protect the corresponding ultrasonic vibrator.

3. The massage device of claim 2, wherein a control panel is arranged on the cover shell of one of the two rigid clamp plates; a control circuit board that is electrically connected to a corresponding ultrasonic vibrator and said control panel is arranged on an inner side of each cover shell.

4. The massage device of claim 1, wherein each of the massage heads comprises a massage part with a surface disposed with a plurality of massage protrusions, a screw part connected to the massage part, and two tightening nuts; the screw part is selectively inserted into one of the through holes, and the two tightening nuts are screwed onto the screw part on both sides of said one of the through holes respectively, thereby allowing the screw part to be detachably and adjustably installed in said one of the through holes.

5. The massage device of claim 4, wherein a drug supply channel is provided on each of the massage heads penetrating from the surface of the massage part provided with the plurality of massage protrusions all the way through two ends of the screw part along an axial direction of the screw part; one of the two ends of the screw part distal from the massage part is also provided with an interface part connected to the drug supply channel.

6. The massage device of claim 5, wherein the massage part is also provided with a recess on the surface of the massage part provided with the plurality of massage protrusions, and the drug supply channel penetrates through a bottom surface of the recess; the massage protrusions are arranged circumferentially around the recess.

7. The massage device of claim 1, wherein support legs are detachably provided at four corners respectively of one of the two rigid clamp plates.

8. The massage device of claim 7, wherein each of the support legs comprises a support leg body, a threaded protrusion arranged on the support leg body, and a locking nut; the threaded protrusion of the support leg body is inserted into a respective one of the through holes at the four corners of said one of the rigid clamp plates, and the locking nut is screwed onto the threaded protrusion.

9. The massage device of claim 8, wherein the support leg body comprises a fastener with a screw hole, a support leg member with a screw rod, and a tightening nut screwed onto the screw rod.

10. The massage device of claim 1, wherein a quantity of the shoulder straps is two; a cutaway portion is formed on a top edge each of the two rigid clamp plates between the two shoulder straps.
